(19) United States
(12) Patent Application Publication
(10) Pub. No.: US 2009/0277028 A1
(43) Pub. Date: Nov. 12, 2009

(54) Electrical template package

(76) Inventor: Richard Oliver Dunn, Fort Payne, AL (US)

Correspondence Address: Richard Oliver Dunn II, 302 A 9th St. N.W., Fort Payne, AL, 35967, US

(21) Appl. No.: 12/075,293

(22) Filed: May 6, 2008

(51) Int. Cl. G01B 1/00

(52) U.S. Cl. 33/528

(57) ABSTRACT

This is a set of plastic templates for drawing the location of an electrical box on a drywall panel. Each set will include 6 templates with each template having the same basic shape as the type of electrical box for which it will be used. After measuring the correct height with a tape measure center the cut out hole of the template over the marking and trace. Cut along the traced line and remove the cut out portion of drywall. Insert the box or enclosure.

### FIELD OF INVENTION

The invention herein relates to the installation of electrical boxes and enclosures.

### BACKGROUND OF INVENTION

Generally when you prepare a wall for electrical devices, you get the box and trace it on the wall or ceiling. It is not always efficient to carry each type of box or enclosure for layout purposes. Moreover it requires assembly for some boxes. Accordingly there is a need for an electrical template package, which will allow you to trace a pattern quickly and precisely.

### SUMMARY OF INVENTION

The present invention is a template package, which consists of 6 templates. Each template of the present invention provides a quick and accurate way to trace the cutout area of an electrical device enclosure on dry wall or plaster. The template of the desired box is held in place with one hand against the dry wall or plaster and traced with a pencil with the other hand.

### DESCRIPTION OF DRAWINGS

To better understand the present invention refer to the following description in conjunction with the drawings within.

FIG. 1 illustrates a template for a single gang metal cut-in box.

FIG. 2 illustrates a template for a double gang metal cut-in box.

FIG. 3 illustrates a template for a single gang mud ring or MP1 data jack.

FIG. 4 illustrates a template for a double gang mud ring.

FIG. 5 illustrates a template for a six-inch can light.

FIG. 6 illustrates a template for an eight-inch can light.

### DESCRIPTION OF THE INVENTION

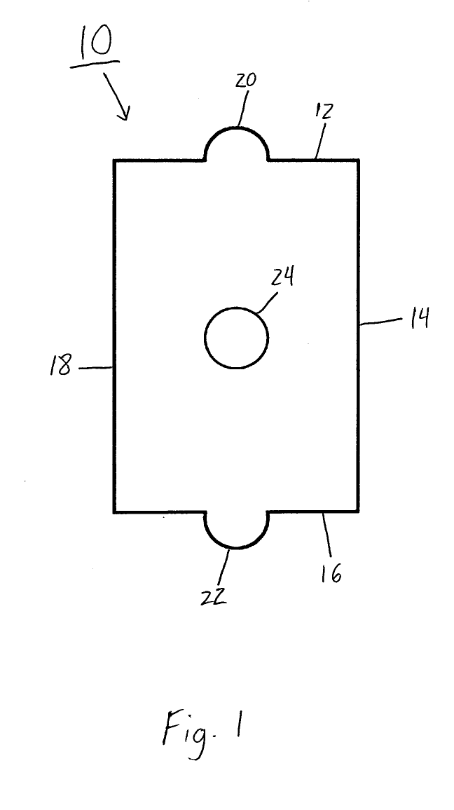

FIG. 1 illustrates a first embodiment of the present invention wherein template 10 is illustrated. Template 10 is rectangular in shape. The top is 12, right size 14, bottom 16, left side 18. The top edge has a half circle protrusion (20 on top). The bottom edge has a half circle protrusion (22 on bottom). The middle of the template has a hole in it (24 in the middle).

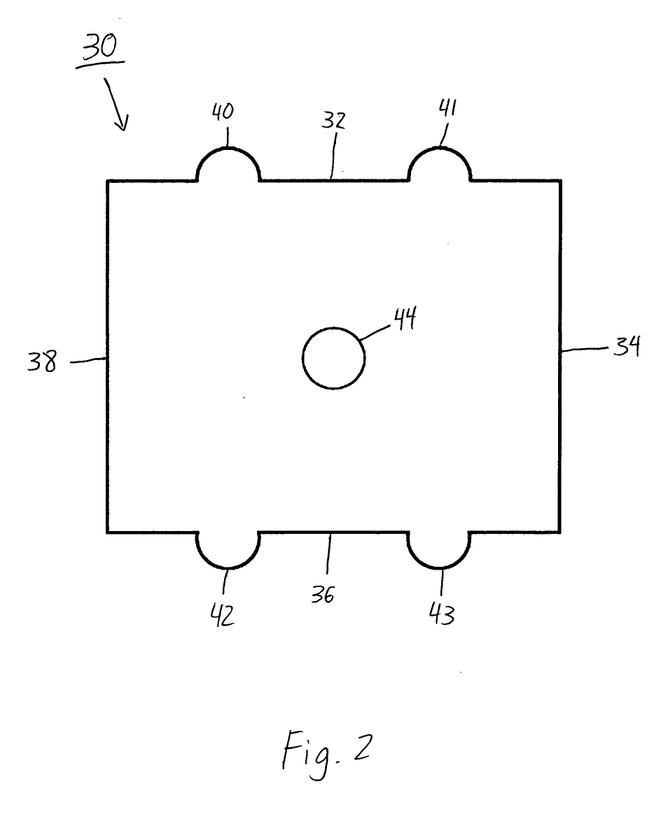

FIG. 2 illustrates a second embodiment of the present invention wherein template 30 is illustrated. The top is 32, right side 34, bottom 36, left side 38. The top edge has two half-circle protrusions (40 and 41 on top). The bottom edge has two half-circle protrusions (42 and 43 on bottom). The middle of the template has a hole in it (44 in the middle).

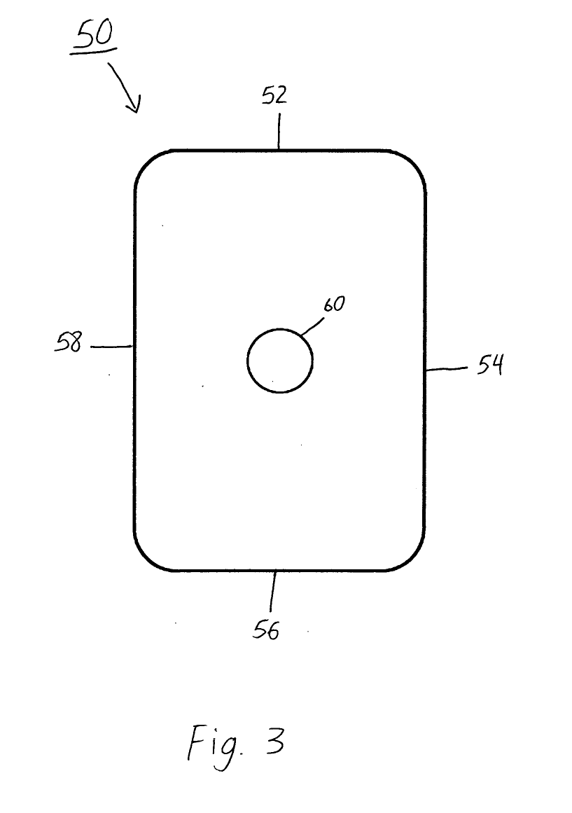

FIG. 3 illustrates a third embodiment of the present invention wherein template 50 is illustrated. The top is 52, right side 54, bottom 56, left side 58. The middle of the template has a hole in it (60 in the middle).

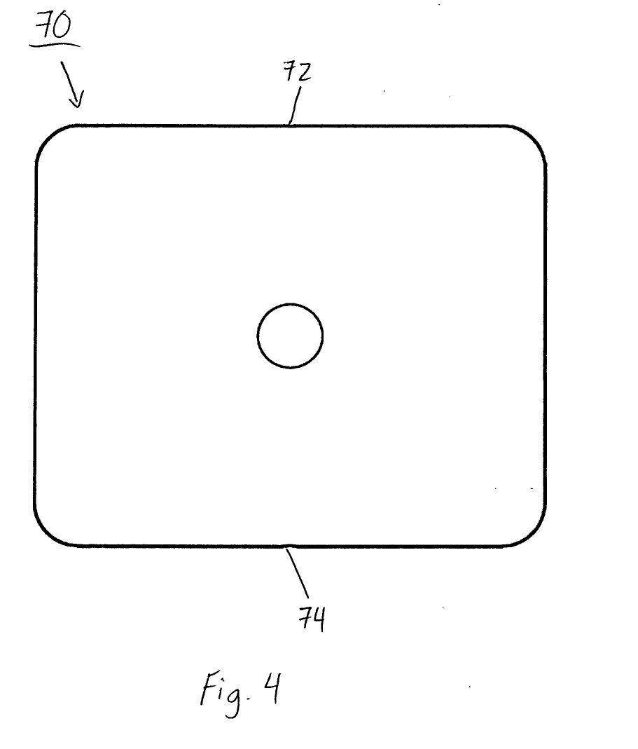

FIG. 4 illustrates a fourth embodiment of the present invention wherein template 70 is illustrated. The template in FIG. 4 is the same as the template in FIG. 3 except that the length of the top 72 and the length of the bottom 74 is greater.

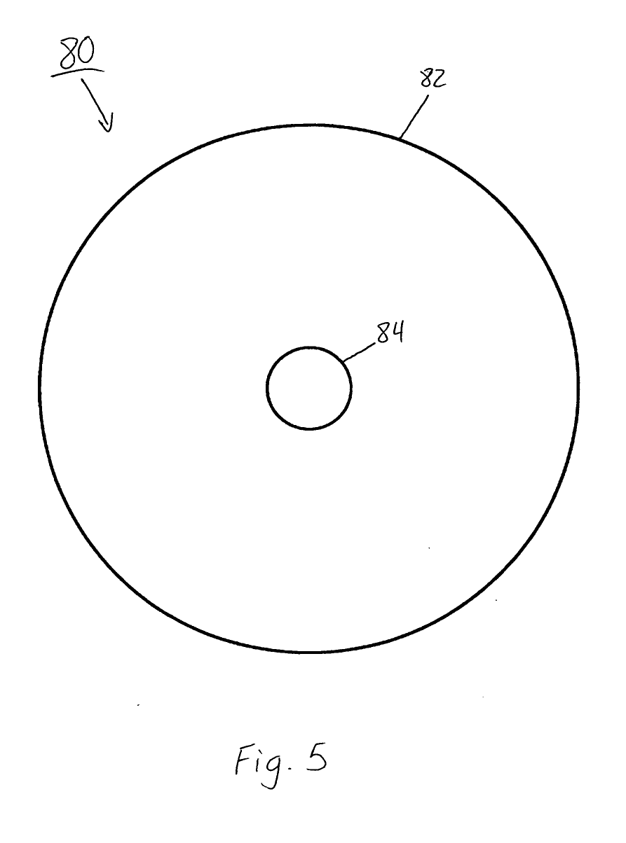

FIG. 5 illustrates a fifth embodiment of the present invention wherein template 80 is illustrated. 82 is six inches in diameter. 84 is the same hole in the middle as it is in all the templates FIG. 1-6.

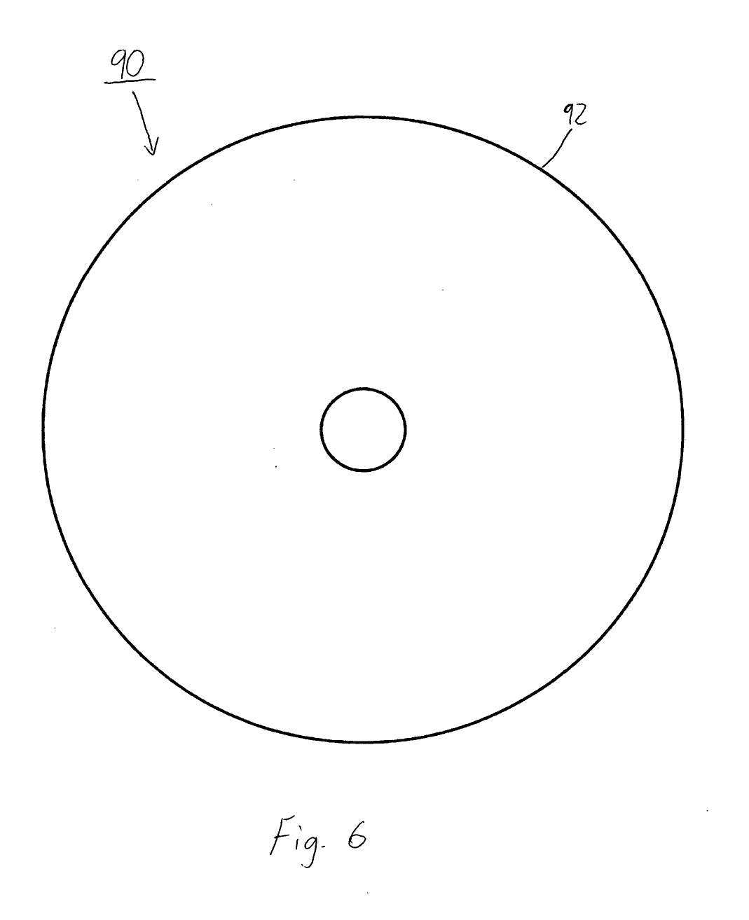

FIG. 6 illustrates a sixth embodiment of the present invention wherein template 90 is illustrated. FIG. 6 is the same as FIG. 5 except that 92 is eight inches in diameter.

The preferred embodiment of the invention described will be understood by those skilled in the art that various changes may be made without departing from the scope.

What is claimed is:

1. An electrical Template package consisting of six templates, each one slightly larger than the electrical box or enclosure for which it would be used.

2. The template of claim 1 wherein said template is made from a plastic material.
